(19) United States
(12) Patent Application Publication
(10) Pub. No.: US 2015/0089020 A1
(43) Pub. Date: Mar. 26, 2015

(54) LIVE VIDEO CONTENT EXCHANGE

(71) Applicant: LIVEU LTD., Kfar Saba (IL)

(72) Inventor: Baruch Yosef Altman, Pardes Hanna (IL)

(73) Assignee: LIVEU LTD., Kfar Saba (IL)

(21) Appl. No.: 14/386,803

(22) PCT Filed: Jun. 3, 2013
(86) PCT No.: PCT/IB2013/054551

§ 371 Date: Sep. 21, 2014

Related U.S. Application Data
(60) Provisional application No. 61/658,418, filed on Jun. 12, 2012.

(51) Int. Cl. H04L 29/06

(52) U.S. Cl. CPC H04L 65/608; H04L 65/607
USPC 709/217

(57) ABSTRACT

A method for content exchange includes receiving at an exchange server (22) from a content provider (26, 32), among multiple content providers in communication with the exchange server, metadata with respect to a live video feed currently available from the content provider. Using at least some of the metadata, an offer of the live video feed is presented from the exchange server to one or more potential buyers (28). Upon receiving, at the exchange server, an acceptance of the offer by at least one of the buyers, the live video feed is routed to the at least one of the buyers.

### CROSS-REFERENCE TO RELATED APPLICATIONS

This application claims the benefit of U.S. Provisional Patent Application 61/658,418, filed Jun. 12, 2012. This application is a continuation-in-part of U.S. patent application Ser. No. 12/863,723, filed Jan. 25, 2010, in the national phase of PCT Patent Application PCT/IL2009/000099, filed Jan. 25, 2009, claiming the benefit of U.S. Provisional Patent Application 61/006,581, filed Jan. 23, 2008. All of these related applications are incorporated herein by reference.

### FIELD OF THE INVENTION

The present invention relates generally to systems and methods for exchanging of digital content, and particularly to conveying live multimedia streams between providers and users of such streams.

### BACKGROUND

The above-mentioned U.S. patent application Ser. No. 12/863,723 (published as US 2010/0299703) describes a live uplink transmission and broadcasting management system for managing live uplink transmissions and broadcasting events. The system includes a publication portal and other means for publishing transmissions of live events and a database for storing metadata, system data, broadcast data and user data. A broadcast manager receives and processes in real-time metadata information related to live uplink transmission events and updates the publication portal accordingly. Alerts are also provided to potential viewers by means such as emails, RSS, and SMS.

The system described in US 2010/0299703 can be used particularly to distribute live content provided by “virtual broadband” transmitting units, as described in U.S. Pat. No. 7,948,933, whose disclosure is incorporated herein by reference. Such a transmitting unit includes a stream generator to generate multiple data streams from an incoming media stream, and a transmission manager to control the upload of the multiple data streams over multiple transmission channels to at least one wireless communication network. A virtual broadband receiver (also described in U.S. Patent Application Publication 2011/0115976), receives the multiple media data streams over multiple data connections, and an assembly engine assembles the data streams into a single media stream.

A number of on-line services have been developed to facilitate distribution of video content. For example, Paya (www.paya.com) is a tool for listing, finding, buying and selling digital content, which is said to enable content creators to capture more value from their creative work and for buyers to find content they need for any project. Paya claims to let videographers and photographers “unlock new value from their creative work” using the Web. Other examples include Storyful (www.storyful.com), which bills itself as “the first news agency of the social media age,” and Citizenside (www.citizenside.com), whose goal is to create an online community of amateur and independent reporters, where users can upload photos and videos for sale to media outlets.

### SUMMARY

Embodiments of the present invention provide improved methods and systems for conveying live multimedia content between content providers and users of the content.

There is therefore provided, in accordance with an embodiment of the present invention, a method for content exchange, which includes receiving at an exchange server from a content provider, among multiple content providers in communication with the exchange server, metadata with respect to a live video feed currently available from the content provider. Using at least some of the metadata, an offer of the live video feed is presented from the exchange server to one or more potential buyers. Upon receiving, at the exchange server, an acceptance of the offer by at least one of the buyers, the live video feed is routed to the at least one of the buyers.

Typically, the metadata include a purchase cost of the live video feed, and presenting the offer includes offering a purchase price to the one or more buyers based on at least the purchase cost. Additionally or alternatively, the metadata may include at least one metadata item selected from a group of metadata items consisting of keywords, a story, a list of timestamps in the video feed, a location of the live video feed, an identifier of a device producing the live video feed, and information regarding ownership and distribution rights in the live video feed.

In some embodiments, the metadata provide a preview of the live video feed, and presenting the offer includes offering the preview for viewing by the one or more buyers. The preview may be presented at a reduced quality level relative to the live video feed. Additionally or alternatively, the preview may include the live video feed overlaid with at least one of text, graphics, and audio. Typically, preview includes a portion of the live video feed.

In a disclosed embodiment, the one or more buyers include at least one content distributor, and routing the live video feed includes providing the live video feed to the at least one content distributor. Typically, the live video feed is routed to the at least one content distributor for streaming to subscribers of the content distributor.

The live video feed may be provided by the content provider by transmitting video data simultaneously over multiple bonded communication channels.

In some embodiments, routing the live video feed includes receiving the live video feed in a proxy device associated with the exchange server, and transmitting the live video feed from the proxy device to the at least one of the buyers. Alternatively, routing the live video feed may include causing a communication device of the content provider to transmit the live video feed directly to the at least one of the buyers.

Typically, the method includes creating an accounting or billing record for the live video feed at the exchange server responsively to the offer accepted by the at least one of the buyers.

In a disclosed embodiment, the routing of the live video feed is stopped and resources applied in routing the feed are released upon termination of the feed.

Typically, routing the live video feed includes causing the live video feed to be transmitted over one or more networks to the at least one of the buyers at a level of quality of the received live video feed. In disclosed embodiments, routing the live video feed includes causing the live video feed to be transmitted over at least one network, selected from a group of networks consisting of Internet, satellite communications, content distribution networks (CDNs), wide area networks, local area networks, mirrored communications, and cache-based communications.

In some embodiments, receiving the acceptance includes receiving a counter-offer from the at least one of the buyers, and routing the live video feed in response to the counter-offer.

Routing the live video feed may include transcoding and delivering the live video feed to each buyer at a quality level specified for the buyer.

In one embodiment, the method includes receiving from a buyer markings with respect to the live video feed according to at least one of timestamps in the live video field and the metadata.

Additionally or alternatively, the method may include offering to the potential buyers at least one recorded portion of the live video feed concurrently with the actual live video feed.

The offer may be generated responsively to at least one factor, selected from a group of factors consisting of a quality of service of the at least one video feed, a service status, rights associated with potential buyers, buyer preferences, provider indications and business terms.

There is also provided, in accordance with an embodiment of the present invention, a method for content exchange, which includes receiving at an exchange server from a video provider, among multiple video providers in communication with the exchange server, a tender of one or more timeslots available for provision of a live video feed from a specified location of the video provider. In response to the tender, an offer is presented, from the exchange server to one or more potential buyers, indicating the timeslots available and the specified location. Upon receiving, at the exchange server, an acceptance of the offer by at least one of the buyers with respect to at least one of the timeslots, the live video feed is routed from the content provider to the at least one of the buyers during the at least one of the timeslots.

There is additionally provided, in accordance with an embodiment of the present invention, a method for content exchange, which includes receiving at an exchange server from a buyer, among multiple buyers in communication with the exchange server, a request for provision of a live video feed from a specified location during one or more specified timeslots. In response to the request, an offer is presented, from the exchange server to one or more video providers in communication with the exchange server, indicating the specified timeslots and the specified location. Upon receiving, at the exchange server, an acceptance of the offer by at least one of the video providers with respect to at least one of the timeslots, the live video feed is routed from the at least one of the video providers to the buyer during the at least one of the timeslots.

There is further provided, in accordance with an embodiment of the present invention, apparatus for content exchange, which includes a communication interface, which is coupled to communicate with multiple content provider and one or more potential buyer. A processor is configured to receive, via the communication interface, metadata from a content provider with respect to a live video feed currently available from the content provider, and to present, responsively to the metadata, via the communication interface, an offer of the live video feed to the one or more potential buyers, and upon receiving an acceptance of the offer by at least one of the buyers, to route the live video feed to the at least one of the buyers.

There is moreover provided, in accordance with an embodiment of the present invention, a computer software product, including a non-transitory computer-readable medium in which program instructions are stored, which instructions, when read by a computer that is coupled to communicate with multiple content providers and one or more potential buyers over a network, cause the computer to receive, via the network, metadata from a content provider with respect to a live video feed currently available from the content provider, and to present, responsively to the metadata, via the communication interface, an offer of the live video feed to the one or more potential buyers, and upon receiving an acceptance of the offer by at least one of the buyers, to route the live video feed from the content provider to the at least one of the buyers.

The present invention will be more fully understood from the following detailed description of the embodiments thereof, taken together with the drawings in which:

### BRIEF DESCRIPTION OF THE DRAWINGS

FIG. 1 is block diagram that schematically illustrates a system for live media exchange, in accordance with an embodiment of the present invention;

FIG. 2 is a block diagram that schematically illustrates a media exchange server, in accordance with an embodiment of the present invention; and

FIG. 3 is a flow chart that schematically illustrates a method for live media exchange, in accordance with an embodiment of the present invention.

### DETAILED DESCRIPTION OF EMBODIMENTS

In today's world of instant news and viewers who are always connected to their video receivers, valuable live video content is typically generated concurrently at many locations, spread around the globe. Distributors of such content, such as news and entertainment broadcasters, are generally unable to deploy camera crews at all such locations at any given time, or may wish to reduce the costs associated with such operations. On the other hand, camera operators who do happen to be at the site of a newsworthy event may not have the connections necessary to distribute the video streams that they capture to a wide audience in real time, when the video is in greatest demand and of greatest value.

Furthermore, streaming high-quality live video (SD, HD and above, at several Mbps or more) with minimal added latency over the Internet around the globe with high efficiency and high QoS (targeting lossless transmission) is currently very difficult, as Content Delivery Network providers (CDNs) have targeted and are therefore configured for delivery of lower-quality video (a few hundred kbps) to multiple end-users.

Embodiments of the present invention that are described herein address these difficulties by providing a computerized live video exchange, which matches providers of live video content with potential buyers in real time. In these embodiments, an exchange server receives metadata from content providers with respect to live video feeds that are currently available from the content providers. The metadata characterize the content in a format that can be quickly appreciated by potential buyers, and also include cost and other purchase terms offered by the content provider. Based on these metadata, the exchange server automatically (or semi-automatically, with human intervention) offers the live video feed to multiple potential buyers, together with the purchase price and terms. When a buyer replies to the exchange server with an acceptance of the offer, the server routes the live video feed from the content provider to the buyer, either through a proxy, typically operated by the exchange, or directly from provider to buyer.

The exchange in accordance with embodiments of the present invention actually facilitates creating an efficient market for live video content, which enables buyers, such as broadcasters, to maximize the choice and value of live video content that they are able to offer to their subscribers. At the same time, this exchange enables content providers to increase the value that they are able to receive for video content that they generate. In an alternative embodiment, the exchange receives tenders from video providers of timeslots during which they will be available to provide a live video feed from a specified location and offers these timeslots to potential buyers. When a buyer accepts such an offer, the exchange server will route the live video feed from the content provider to the buyer (or to multiple such buyers) during the timeslot or timeslots that the buyer has agreed to purchase.

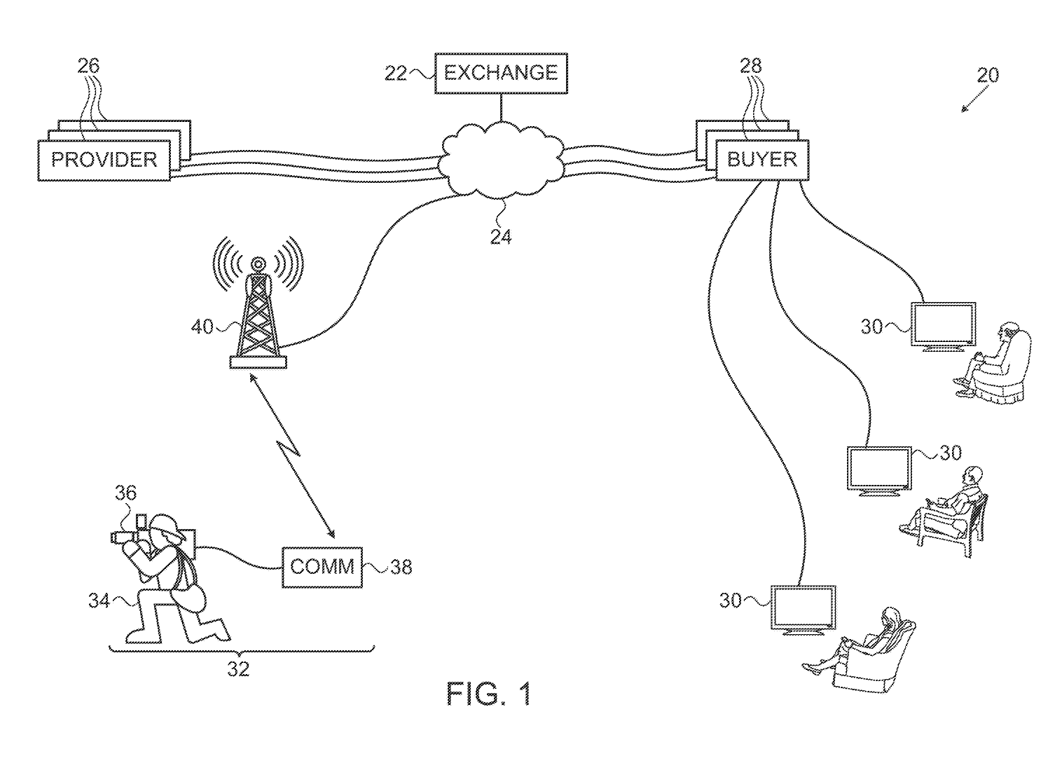

FIG. 1 is block diagram that schematically illustrates a system 20 for live media exchange, in accordance with an embodiment of the present invention. A media exchange server 22 communicates over a network 24 with providers 26 and buyers 28 of live video content. (Video content, in the context of the present description and in the claims, typically, although not necessarily, includes a corresponding audio feed, s well.) Network 24 typically comprises the Internet, but may, additionally or alternatively, comprise one or more telephone (cellular and land-based) networks, satellite communication networks, content distribution networks, wide area networks, local area networks, mirrored communications, cache-based communications, or any other suitable types of available communication networks that are known in the art.

Buyers 28 are typically video content distributors, such as network broadcasters, new-media publishers, or other asset owners, who arrange and pass the video content on to subscribers 30. Such distributors may also offer their subscribers access to stored video content on demand (VoD); but system 20 generally and exchange server 22 specifically offer live, streaming video content, which is made available to the subscribers in real time, as the content is generated by providers 26. In some cases, buyers 28 may also comprise end-consumers of the content, as described in the above-mentioned US 2010/0299703.

Providers 26 may comprise organizations, which themselves deploy one or more camera crews and feed video streams and/or metadata to exchange server 22, or they may comprise independent, freelance suppliers 32. In this example, supplier 32 is a cameraman 34, with video capture equipment 36 and a communications unit 38, deployed in the field at the location of an event of interest. Communications unit 38 may be configured to transmit video data, as well as metadata, simultaneously over multiple bonded communication channels via one or more networks, such as a cellular network 40. (This sort of bonded communication is described in the above-mentioned U.S. Pat. No. 7,948,933.) Other providers 26 may similarly use this sort of bonding to communicate over available communication links.

Other video feeds may be input via other, means of communication (whether bonding or not), such as a satellite-delivered feed into a broadcaster's control room, from which it is then uploaded into the exchange. Alternatively or additionally, camera 36 or other video sources and communications unit 38 may be fully automatic, without requiring an operator on site. Such sources may be non-broadcasting, such as closed-circuit television (CCTV), a digital video recorder (DVR), or other security video feed, connected to a local area network or wireless communications unit, for example. In such cases, provider 26 may be a non-broadcasting or non-media organization, such as a condominium management company, a security camera owner or operator, a police force, a military unit, or any other governmental or non-governmental organization.

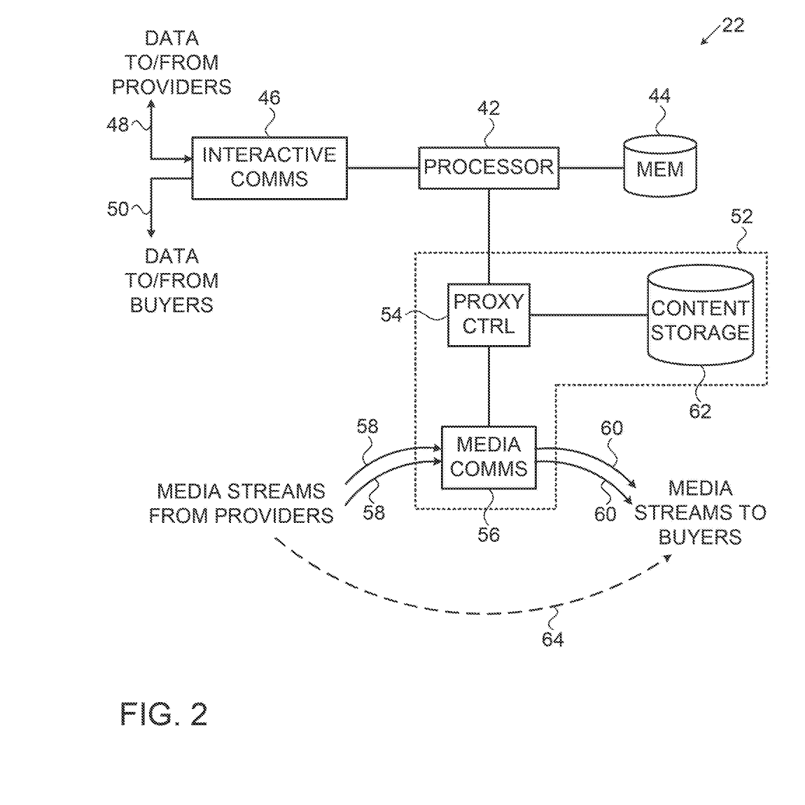

FIG. 2 is a block diagram that schematically illustrates media exchange server 22, in accordance with an embodiment of the present invention. The operations of server 22 are controlled by a processor 42, having a suitable memory 44 and communication interface 46 for interactive communications with providers 26, 32 and buyers 28. Processor 42 typically comprises a general-purpose computer processor, or a cluster of such processors, which is programmed in software to carry out the functions that are described herein. This software may be downloaded to server 22 in electronic form, over a network, for example. Additionally or alternatively, the software may be stored in tangible, non-transitory, computer-readable media, such as optical, electronic, or magnetic memory, which may be embodied in memory 44. Further alternatively or additionally, at least some of the functions of processor 42 may be implemented in dedicated or programmable hardware logic.

Communication interface 46 maintains data links 48 via network 24 with providers 26, 32 and data links 50 via network 24 with buyers 28. Data links 48 and 50 carry metadata concerning video content on offer from providers to buyers and may themselves comprise multi-channel bonded links. (Transmission of the live video content itself is described further hereinbelow.) The metadata may comprise any and all data concerning the video content, other than the video content itself. For example, the metadata received over links 48 may include keywords describing the video content (possibly in a standard format, such as NewsML), the location of the live video feed, an identifier of the device producing the live video feed, a story, a list of timestamps in the video feed, and/or information regarding ownership and distribution rights in the live video feed. Additionally or alternatively, the metadata may include business terms, such as the purchase cost of the live video feed offered by the supplier.

Processor 42 processes the incoming metadata received over links 48 in order to generate and transmit the corresponding content offers to potential buyers over links 50. These offers may be pushed to the buyers over suitable channels, such as e-mail, SMS text messages, RSS feeds, and/or social network channels. Additionally or alternatively, the offers may be posted on a Web page, possibly providing limited access rights per viewer and with the content automatically matched to fit the rights and interests of each such viewer. The offers typically contain, with respect to each available feed, relevant elements of the metadata, including a purchase price to the buyers based on the purchase cost offered by the provider. Processor 42 may forward a given offer to all buyers 28, but alternatively, the processor may filter offers according to known buyer profiles and preferences, and thus push a given offer only to those buyers who have indicated an interest in video content of the type that is offered or are likely to have an interest in accepting it and have suitable rights to actually buy it.

Elements of the metadata, including the price, may change over time while a video feed is in progress. Such changes may depend, for example, on developments in the subject matter of the feed and on the extent of provider supply and buyer demand for the subject matter in question. Processor 42 may post these changes to buyers 28, who then have the option of continuing with or leaving the feed.

The metadata provided to buyers 28 may also include or otherwise provide (via a hyperlink, for example) a preview of the live video feed. This preview may comprise a short segment of the video content, and it may be transcoded and/or trans-rated and presented at a reduced quality level relative to the actual live video feed itself. For example, the preview may be transcoded from the original feed and have lower resolution than the actual video feed. Alternatively or additionally, the preview may have an overlaid text, graphic, and/or audio stating, for example, “not for commercial use.” Providers 26 may themselves generate and transmit such previews to server 22 over links 48, whereupon the server offers these previews to buyers 28. Alternatively, when a provider, such as supplier 32, streams high-quality video to server 22, the server may transcode the video input (by itself or using a third-party service) in order to generate the preview. Similarly, a graphical overlay and other manipulations may be applied in this manner, typically in real time or near-real time. Offers of video content from server 22 to buyers 28 may include the preview or parts of it (edited or not) as an embedded file, or they may alternatively contain a link to the preview on server 22 or another location.

Although the features described above mainly involve conveyance of metadata from providers 26 to buyers 28 via links 48 and 50, these links may additionally be used to convey requests and instructions from buyers to providers. For example, while a buyer is receiving a video feed that is transmitted by a given provider, the buyer may send messages to the provider, via server 22, requesting certain actions, such as changing the camera zoom, angle or location.

Server 22 typically provides not only the services of brokerage between providers 26 and buyers 28 that are described above, but may also channel the actual live video feeds between the providers and the buyers who have decided to purchase them. This latter function is typically carried out by a proxy device 52 that is associated with exchange server 22, either as an integral part of the server or as a separate, connected unit. Proxy device 52 typically comprises a controller 54, which controls and receives data from a media communication interface 56. Controller 54 may comprise a general-purpose software-driven processor and/or suitable hardware logic, like processor 42 described above. Alternatively or additionally, at least certain functions of controller 54 may be carried out by processor 42.

Media communication interface 56 comprises suitable network links, along with switching and routing hardware, which enable it to receive live video input feeds 58 from providers 26, 32 and to stream corresponding output feeds 60 to buyers 28. Interface 56 may have bonding capabilities, so as to receive elements of a video feed over multiple parallel network channels from a provider, such as supplier 32, and to combine the elements into a single, broadband output feed. This feature of proxy device 52 relieves the supplier of the need to maintain his own, dedicated bonding receiver. Additionally or alternatively, interface 56 may have transcoding capabilities, so as to change the format of a given input feed 58 to satisfy the particular requirements of different buyers 28 in terms of video standards, resolution, formats and other parameters according to their preferences, rights and business terms, as well as system status and conditions (e.g., congestion). Proxy controller 54 invokes these functions as needed in real time, as the video feed progresses, and may turn them off when no longer needed in order to conserve computing resources, bandwidth and power.

Optionally, proxy controller 54 may store content received from live input feeds 58 in a content repository 62, such as a disk or other memory. Using this stored content, server 22 may offer buyers who join a feed in the middle the opportunity to “catch up” by receiving and distributing all or a part of the earlier portion of the feed. Alternatively or additionally, server 22 may offer a potential buyer the means to control and to download or stream only certain specific portions of the recorded material, so that only the more interesting portions are downloaded or streamed, thus saving extended download time in some circumstances (and scarce production resources and money). Means for marking such video portions, according to timestamps or metadata fields, for example, may be offered so that later-coming buyers may enjoy the benefit of someone else having reviewed and marked the interesting parts for them, including adding metadata and potential publishing information. Further alternatively or additionally, server 22 may offer the recorded content from repository 62 to buyers 28 for later purchase and distribution, typically (although not necessarily) at a reduced price relative to the previous live feed.

Additionally or alternatively, proxy device 52 may interface to and offer other added-value services along with the video streams that it passes from provider 26 to buyer 28. For example, proxy device 52 may add or remove logos to and from video streams, as well as watermarks and other digital rights management (DRM) data. As a further example, the proxy device may route a certain video stream to a third-party service that provides simultaneous translation or subtitle transcription of audio content. As another possibility, proxy device 52 may combine segments from the same provider or even from two or more different providers with cameras deployed in different locations at the same event to provide a mixed video feed containing time slices or windows from multiple cameras.

As yet another option, server 22 may direct a given provider 26 to stream a video feed over a direct link 64 via network 24 to one or more of buyers 28, rather than through proxy device 52. This option is useful in conserving bandwidth of the proxy device and reducing communication latency, particularly when there is only a single buyer for a given video feed.

Processor 42 and proxy controller 54 may record every action and generate records for accounting, billing, authentication, authorization, performance analysis, unusual patterns, and other purposes.

The above description represents just one way of implementation, and the processors, proxies, storage devices and interfaces used in embodiments of the present invention may be implemented in various ways, such as clusters, distributed implementation between several service providers, cloud hosting farms, or even installations at the content provider facilities, mirroring in different locations, and so on. As one example, transcoding and/or encoding may be done in one or more other locations other than or in addition to interface 56 as described above.

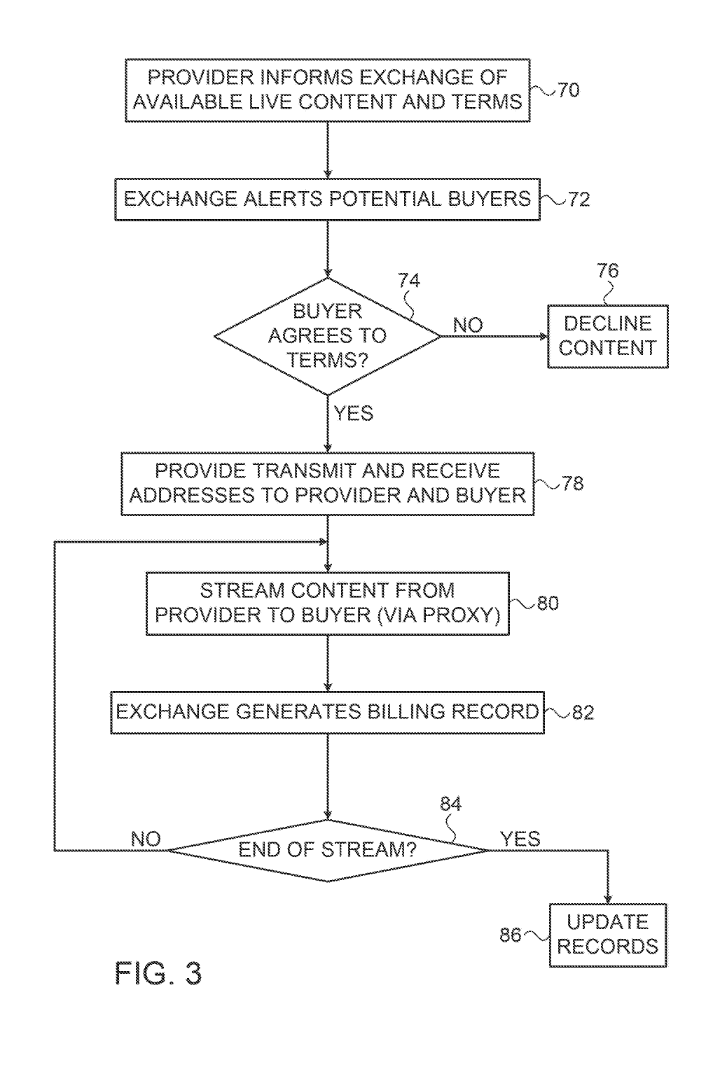

FIG. 3 is a flow chart that schematically illustrates a method for live media exchange, in accordance with an embodiment of the present invention. The method is described here, for the sake of convenience and clarity, with reference to the elements of system 20 and server 22 that are shown in FIGS. 1 and 2. In alternative embodiments, however, aspects of this method may be implemented in other system and server configurations, as will be apparent to those skilled in the art after reading the present description. All such alternative implementations are considered to be within the scope of the present invention.

The method of FIG. 3 is initiated when one of providers 26 informs exchange server 22 of an available item of live video content, at a provider notification step 70. This notification may be posted in advance of the event that is to be covered by the video feed, or in real time, as the event is in progress. The notification typically contains metadata, as explained above, which may include business terms relevant to a recipient (potential buyer), and specifically the cost at which the content is offered to that recipient. This cost may be stated in terms of the entire video feed or certain time segments, and it may be a fixed figure or a recommended figure, which server 22 is authorized to adjust depending on demand and other conditions.

The cost may be a flat figure per buyer, or it may be based on characteristics of the video feed and the rights on offer. For example, the cost may be based on the extent of distribution rights that are offered to or desired by a given buyer. Thus, pricing may vary depending on whether the distribution by a given buyer is to be exclusive or non-exclusive, as well as the territories and channels over which the buyer is entitled to distribute the video content. Additionally or alternatively, provider 26 or exchange server 22 may offer different products based on the same feed, such as a high-definition (HD) version and a standard definition (SD) version. As noted earlier, the cost of a given feed may vary over time, and may be set to different values depending on whether the feed has not yet started, or is currently in progress, or has already finished and a recording is on offer. The cost may also vary depending on factors relating to supply and demand, such as the number of buyers bidding to receive a given feed or the number of suppliers offering feeds of the same event. In some cases, server 22 may auction a feed among multiple buyers.

In an alternative embodiment, a provider, such as supplier 32, may offer specific time slots for sale, during which the supplier is available to provide a video feed via either multi-channel, bonded transmission or conventional single channels. These time slots are offered on a similar basis to the live video feeds described above: The supplier typically identifies his or her capabilities and location, and thus enables buyers 28 to find and engage a supplier in a desired location at a desired time. As in the case of video feeds, the supplier may offer a purchase cost per time slot (or for a group of time slots), which the buyer may accept, decline, or seek to renegotiate. This arrangement also enables server 22 to auction time slots of supplier 32 when the supplier is or is expected be in a location of high demand, as well as to offer a reverse auction to multiple suppliers on behalf of a buyer when the multiple suppliers are all deployed at or near a location of interest.

In yet another alternative embodiment, server 22 may receive requests from buyers 28 for provision of a live video feed from a specified location during one or more specified timeslots. The exchange server may then present the offer to providers, such as supplier 32, indicating the specified timeslots and the specified location. When a provider accepts such an offer, the server will route the live video feed from the provider to the buyer during the appropriate timeslots.

Server 22 alerts buyers 28 that a matching item of video content is available, at a buyer notification step 72. (Provider time slots are handled in a similar manner, and the description below of how live video feeds are exchanged through server 22 should be understood as applying to the sale of such time slots, as well, mutatis mutandis.) The alert, as noted above, may be pushed to selected buyers and/or posted electronically for browsing or search by the buyers, and typically includes the price and terms on which the video feed is offered. Buyers 28 typically inform server 22 of their interest profile in advance, for use in filtering the content that server 22 offers them. In addition, buyers may rank content that they do receive, thus enabling server 22 to accumulate statistical profiles of the sort of content and the identities of providers 26 that best match the needs and interests of each buyer.

When server 22 presents available content to a given buyer 28, it may give higher priority to content items that are likely to fit the buyer's profile, as well as items that are expected to be of high interest due to their subject matter and topicality, for example. In generating offers to buyers, the server may take into account factors such as the quality of service of the at least one video feed, a service status, rights associated with potential buyers, buyer preferences, provider indications and business terms.

Server 22 checks responses from buyers 28 to determine whether a buyer has agreed to purchase a given content item, at a purchase step 74. Typically, such a response from a buyer will indicate that the buyer has accepted the offered terms. Alternatively, server 22 may be configured to allow buyers to make counter-offers, typically at a lower price and/or improved terms. The server may accept these offers if they are within a range previously agreed to by the provider, or it may otherwise pass such offers to the provider for approval. If no buyer is willing to purchase the content offered by the provider, server 22 indicates to the provider that the content has been declined, at a refusal step 76. Even under these conditions, server 22 may record the content in repository 62 for possible subsequent sale.

Assuming one or more buyers 28 indicate to server 22 that they are willing to pay the price offered for a given content item, server 22 provides routing information to provider 26 and to the buyer or buyers for transmission and reception of the live video feed, at a routing step 78. For example, server 22 may assign certain ports of media communication interface 56 to receive the input feed 58 from provider 26 and send the output feed 60 to buyer 28, and may then send messages containing the network addresses (such as Internet Protocol [IP] addresses) of these interfaces to the provider and the buyer. In response to these messages, the provider and buyer connect to proxy device 52 and begin transmission and reception. Alternatively, when direct link 64 is to be used, server 22 may simply give buyer 28 the network address of supplier 26, or vice versa. Additionally or alternatively, the buyer may automatically log into communications unit 38 or a similar component as required (e.g., via a proxy communication manager, not shown here), and change the destination IP address, domain name, or other destination settings in the communications unit so that the feed is automatically routed, even if using bonding.

Once provider 26 and buyer 28 have connected to the appropriate addresses (possibly via Web pages, proxies or other means), the provider streams live video content to the buyer, at a streaming step 80, via either proxy device 52 or direct link 64 as appropriate. Server 22 monitors the transmission in order to start, stop and possibly transcode the video feed as necessary. The quality of service may vary from buyer to buyer, while at the highest quality of service, the live video feed is transmitted to the buyer at the full level of quality of the received live video feed.

At the same time, the server generates and updates an accounting and/or billing record corresponding to this transmission, at a billing step 82. The billing amount depends on the agreed prices and terms, as well as other factors such as the duration of transmission, as appropriate, and may be updated as long as the transmission is in progress.

Server 22 continues to monitor the transmission until the video feed is terminated, at an end-of-stream step 84. Termination may be due to any cause, including, for example, manual termination of the feed by the provider, failure, end of video transmission, or end of video input. At this point, the routing of the live video feed is stopped, and resources applied in routing the feed are released. The server updates the final billing records, in order to charge the account of the buyer and credit the provider accordingly (subject to any commission that may be charged by server 22 for the exchange service), an a record update step 86.

Server 22 may also record, collect and use metadata regarding the transmission, such as location, identities, frequencies, rankings, quality, duration, and transaction-related information. These metadata may be used by the server in statistical analysis for purposes of reporting, promotion (including both live and recorded feeds), matching potential buyers and sellers, advance planning of future live transmissions, and transactions relating to current and future events (including services not directly related to video transmission).

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for content exchange, comprising:
receiving at an exchange server from a content provider, among multiple content providers in communication with the exchange server, metadata with respect to a live video feed currently available from the content provider;
using at least some of the metadata, presenting an offer of the live video feed from the exchange server to one or more potential buyers; and
upon receiving, at the exchange server, an acceptance of the offer by at least one of the buyers, routing the live video feed to the at least one of the buyers.

2. The method according to claim 1, wherein the metadata include a purchase cost of the live video feed, and wherein presenting the offer comprises offering a purchase price to the one or more buyers based on at least the purchase cost.

3. (canceled)

4. The method according to claim 1, wherein the metadata provide a preview of the live video feed, and wherein presenting the offer comprises offering the preview for viewing by the one or more buyers.

5. (canceled)

6. The method according to claim 1, wherein presenting the offer comprises providing a preview comprising the live video feed overlaid with at least one of text, graphics, and audio.

7-9. (canceled)

10. The method according to claim 1, wherein the live video feed is provided by the content provider by transmitting video data simultaneously over multiple bonded communication channels.

11. The method according to claim 1, wherein routing the live video feed comprises receiving the live video feed in a proxy device associated with the exchange server, and transmitting the live video feed from the proxy device to the at least one of the buyers.

12. The method according to claim 1, wherein routing the live video feed comprises causing a communication device of the content provider to transmit the live video feed directly to the at least one of the buyers.

13. (canceled)

14. The method according to claim 1, wherein the routing of the live video feed is stopped and resources applied in routing the feed are released upon termination of the feed.

15. The method according to claim 1, wherein routing the live video feed comprises causing the live video feed to be transmitted over one or more networks to the at least one of the buyers at a level of quality of the received live video feed.

16. (canceled)

17. The method according to claim 1, wherein receiving the acceptance comprises receiving a counter-offer from the at least one of the buyers, and routing the live video feed in response to the counter-offer.

18. The method according to claim 1, wherein routing the live video feed comprises transcoding and delivering the live video feed to each buyer at a quality level specified for the buyer.

19. The method according to claim 1, and comprising receiving from a buyer markings with respect to the live video feed according to at least one of timestamps in the live video field and the metadata.

20. The method according to claim 1, and comprising offering to the potential buyers at least one recorded portion of the live video feed concurrently with the actual live video feed.

21. The method according to claim 1, wherein presenting the offer comprises generating the offer responsively to at least one factor, selected from a group of factors consisting of a quality of service of the at least one video feed, a service status, rights associated with potential buyers, buyer preferences, provider indications and business terms.

22. A method for content exchange, comprising:
receiving at an exchange server from a video provider, among multiple video providers in communication with the exchange server, a tender of one or more timeslots available for provision of a live video feed from a specified location of the video provider;
in response to the tender, presenting, from the exchange server to one or more potential buyers, an offer indicating the timeslots available and the specified location; and
upon receiving, at the exchange server, an acceptance of the offer by at least one of the buyers with respect to at least one of the timeslots, routing the live video feed from the content provider to the at least one of the buyers during the at least one of the timeslots.

23. A method for content exchange, comprising:
receiving at an exchange server from a buyer, among multiple buyers in communication with the exchange server, a request for provision of a live video feed from a specified location during one or more specified timeslots;
in response to the request, presenting, from the exchange server to one or more video providers in communication with the exchange server, an offer indicating the specified timeslots and the specified location; and
upon receiving, at the exchange server, an acceptance of the offer by at least one of the video providers with respect to at least one of the timeslots, routing the live video feed from the at least one of the video providers to the buyer during the at least one of the timeslots.

24. Apparatus for content exchange, comprising:
a communication interface, which is coupled to communicate with multiple content provider and one or more potential buyer; and
a processor, which is configured to receive, via the communication interface, metadata from a content provider with respect to a live video feed currently available from the content provider, and to present, responsively to the metadata, via the communication interface, an offer of the live video feed to the one or more potential buyers, and upon receiving an acceptance of the offer by at least one of the buyers, to route the live video feed to the at least one of the buyers.

25. The apparatus according to claim 24, wherein the metadata include a purchase cost of the live video feed, and wherein the offer comprises a purchase price to the one or more buyers based on the purchase cost.

26. (canceled)

27. The apparatus according to claim 24, wherein the metadata provide a preview of the live video feed, and wherein the processor is configured to offer the preview for viewing by the one or more buyers.

28. (canceled)

29. The apparatus according to claim 24, wherein the offer provides a preview comprising the live video feed overlaid with at least one of text, graphics, and audio.

30. (canceled)

31. The apparatus according to claim 24, wherein the one or more buyers include at least one content distributors, and wherein the processor is configured to route the live video feed to the at least one content distributor.

32. (canceled)

33. The apparatus according to claim 24, wherein the live video feed is provided by the content provider by transmitting video data simultaneously over multiple bonded communication channels.

34. The apparatus according to claim 24, and comprising a proxy device which is configured to receive the live video feed and to transmit the live video field to the at least one of the buyers.

35. The apparatus according to claim 24, wherein the processor is configured to cause a communication device of the content provider to transmit the live video feed directly to the at least one of the buyers.

36. (canceled)

37. The apparatus according to claim 24, wherein the routing of the live video feed is stopped and resources applied in routing the feed are released upon termination of the feed.

38. The apparatus according to claim 24, wherein the processor is configured to cause the live video feed to be transmitted over one or more networks to the at least one of the buyers at a level of quality of the received live video feed.

39. (canceled)

40. The apparatus according to claim 24, wherein the processor is configured to receive a counter-offer from the at least one of the buyers, and to route the live video feed in response to the counter-offer.

41. The apparatus according to claim 24, wherein the processor is configured to cause the live video feed to be transcoded and delivered to each buyer at a quality level specified for the buyer.

42. The apparatus according to claim 24, wherein the processor is configured to receive from a buyer markings with respect to the live video feed according to at least one of timestamps in the live video feed and the metadata.

43. The apparatus according to claim 24, wherein the processor is configured to offer to the potential buyers at least one recorded portion of the live video feed concurrently with the actual live video feed.

44. The apparatus according to claim 24, wherein the processor is configured to generate the offer responsively to at least one factor, selected from a group of factors consisting of a quality of service of the at least one video feed, a service status, rights associated with potential buyers, buyer preferences, provider indications and business terms.

45. A computer software product, comprising a non-transitory computer-readable medium in which program instructions are stored, which instructions, when read by a computer that is coupled to communicate with multiple content providers and one or more potential buyers over a network, cause the computer to receive, via the network, metadata from a content provider with respect to a live video feed currently available from the content provider, and to present, responsively to the metadata, via the communication interface, an offer of the live video feed to the one or more potential buyers, and upon receiving an acceptance of the offer by at least one of the buyers, to route the live video feed from the content provider to the at least one of the buyers.
